(19) United States
(12) Patent Application Publication
(10) Pub. No.: US 2008/0291650 A1
(43) Pub. Date: Nov. 27, 2008

(54) Arrangement Having an Electric Motor and a Main Printed Circuit Board, and an Assembly Method

(76) Inventors: Heinz-Josef Hautvast, Brigachtal (DE); Torsten Wahler, Bad Durrheim (DE); Peter Wolf, Niedereschach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/599,218

(22) PCT Filed: Mar. 10, 2005
(86) PCT No.: PCT/EP2005/051069

§ 371 Date: Sep. 22, 2006

(30) Foreign Application Priority Data
Mar. 23, 2004 (DE) 10 2004 014 137.1

(51) Int. Cl. H01R 9/00; B23P 11/00

(52) U.S. Cl. 361/772; 29/428

(57) ABSTRACT

A device provided with an electric motor (7) and a main printed circuit card (8) has contact points (12), wherein the electric motor has a housing and connecting contacts (6) which are conductively connected to the contact points (12), the housing has a first face and a second face opposite thereto, the connecting contacts (6) are mounted in the area of the housing face, the electric motor is arranged with respect to the main printed circuit card (8) in such a way that the second face is remote therefrom. A method for mounting the inventive device is also disclosed. Conventional devices of preceding techniques require important expenditures for mounting and functionality testing. The invention makes it possible to solve the problem in that the electroconductive connection (11) is embodied in flexion-resistant manner at least for torques which are oriented in a direction perpendicular to the longitudinal extension thereof.

### CROSS-REFERENCE TO RELATED APPLICATIONS

This application is a U.S. national stage application of International Application No. PCT/EP2005/051069 filed Mar. 10, 2005, which designates the United States of America, and claims priority to German application number DE 10 2004 014 137.1 filed Mar. 23, 2004, the contents of which are hereby incorporated by reference in their entirety.

### TECHNICAL FIELD

The invention relates to an arrangement having an electric motor and a main printed circuit board with contact points, which electric motor has a housing and connecting contacts which are electrically conductively connected to the contact points, which housing has a first end face and a second end face opposite it, which connecting contacts are arranged in the area of the second end face on the housing, with the electric motor being arranged with respect to the main printed circuit board in such a manner that the second end face faces away from the main printed circuit board. The subject matter of the invention also includes an assembly method for an arrangement such as this.

### BACKGROUND

Conventional arrangements of the type described in the introduction have numerous disadvantages, in particular with respect to the complexity of the assembly process, and functional testing. Normally, cables are used for the electrical connection of the connecting contacts to the contact points and are conductively connected to the contact points and to the connecting contacts by means of plug connections, and must at least be soldered at one of the two connection points. Electric motors frequently have to be arranged in openings or recesses, in which case cables which have already been fitted have to be threaded through these openings as part of the insertion movement. Owing to the unpredictable position of the cables, because they are not dimensionally stable, assembly steps such as these must be carried out manually. During this process, it is nevertheless possible for the threading-in process to be carried out incorrectly and for at least one cable to be jammed in between the electric motor and the recess contour. In addition, the production of the conductive connection by means of the plug contacts requires an entire process step by the assembly personnel. Functional testing requires the plug contacts to be detached in order to pass current through them. The need to connect the plug contacts also creates a risk of error, since it is easy to forget this assembly step, resulting in complex disassembly.

### SUMMARY

Against the background of the problems and disadvantages of the prior art, the invention is based on the object of cost-effectively reducing the effort for production assembly of the arrangement mentioned in the introduction.

The solution according to the invention provides an arrangement comprising an electric motor and a main printed circuit board with contact points, wherein the electric motor has a housing and connecting contacts which are electrically conductively connected to the contact points, the housing has a first end face and a second end face opposite it, the connecting contacts are arranged in the area of the second end face on the housing, with the electric motor being arranged with respect to the main printed circuit board in such a manner that the second end face faces away from the main printed circuit board, the electrically conductive connection is resistant to bending, at least for torques which are oriented in a direction at right angles to the longitudinal extent of the electrically conductive connection, the main printed circuit board has a recess in which the electric motor is arranged, the contact points on the main printed circuit board are in the form of spring contacts, and are arranged on the lower face of the main printed circuit board, and wherein the electrically conductive connection is attached to a molding, by means of which the electrically conductive connection is electrically conductively pressed against the spring contacts.

The electrical connection may comprise at least one flexible printed circuit. The electrically conductive connection can be surrounded by a plastic injection-molded element, in order to stiffen it. The electrical connection may run in a meandering shape in the plastic injection-molded element. The plastic injection-molded element may at least partially surround the electric motor in such a manner that the electric motor is held in a cavity between the main printed circuit board and the plastic injection-molded element. The plastic injection-molded element may have sprung latching hooks, by means of which it is attached to the main printed circuit board. A drive shaft of the electric motor can be oriented at right angles to the main printed circuit board, and projects out of the first end face. The electrically conductive connection can be at least partially surrounded in the area of the conductive contact with the spring contacts by a protective housing, which rests on the main printed circuit board, forming a seal. The spring contacts may be in the form of SMD components. The flexible printed circuit can be attached to the housing by means of adhesive bonding. The flexible printed circuit can be attached to the housing and/or to the molding by means of sprung latching hooks.

The object can also be achieved by a method for assembly of such an arrangement comprising the steps of placing an electric motor on a base mount in an installation direction in a first step, arranging a main printed circuit board, which has a recess for the electric motor, essentially parallel to the base mount in a final position in a second step, so that the electric motor is arranged in the main printed circuit board, and providing the main printed circuit board on its lower face with contact points which are in the form of spring contacts and are electrically connected to connecting contacts on the electric motor on reaching the final position, in that an electrically conductive connection, which is connected to the connecting contacts, is electrically conductively pressed against the contact points by means of a molding.

The configuration of the electrically conductive connection such that, according to the invention, it is resistant to bending, at least for torques which are oriented in a direction at right angles to the longitudinal extent of the connection, results in the assembly of the electric motor with the surrounding components being simplified to a major extent. The dimensional stability according to the invention makes it easier for the assembly personnel to carry out any process of threading the connection into recesses, since this component behaves in a predictable manner. The handling of the electrically conductive connection, for example in order to make contact with it, can equally be carried out blindly, since it cannot be located at an unexpected point. In addition, the risk of mechanical faults being caused as a result of a change in the position of the electrically conductive connection during operation is greatly reduced, because of the dimensional stability.

One particularly expedient development according to the invention provides for the electrical connection to comprise at least one flexible printed circuit. This embodiment is cost-effective, and meets the requirements to solve the problem. Another variant provides for the electrically conductive connection to be surrounded by a plastic injection-molded element, in order to stiffen it. In this case, metallic contact plates can be extrusion-coated, using insert technology, in which case the electrical connection can preferably run in a meandering shape in the plastic injection-molded element in order to prevent damage to the connection as a consequence of relative straining of the two materials with respect to one another.

The plastic injection-molded element can advantageously at least partially surround the electric motor, so that the electric motor is held in a cavity between the main printed circuit board and the plastic injection-molded element. In consequence, the stiffening of the electrically conductive connection by means of the plastic injection-molded element not only carries out the function of simplifying the assembly process, but also protects and holds the electric motor. For this purpose, the plastic injection-molded element can expediently be provided with sprung latching hooks, by means of which it can be attached easily to the main printed circuit board.

The arrangement according to the invention is particularly worthwhile when a drive shaft of the electric motor extends at right angles to the main printed circuit board, and projects out of the first end face of the housing of the electric motor. This is because an arrangement such as this normally results in the need to bridge a greater distance between the contact points of the main printed circuit board and the connecting contacts of the electric motor, and this must be bridged by means of the electrically conductive connection.

In order to avoid plug contacts and the disadvantages associated with them as described in the introduction, it is expedient for the contact points to be in the form of a spring contact, and for it to be possible to press the electrically conductive connection in an electrically conductive manner against the spring contacts, by means of a molding which is secured relative to the electric motor. This allows a positive electrical contact to be made correctly and in a manner which cannot be forgotten, by the main printed circuit board being joined to the electric motor. The molding can in this case support a flexible printed circuit (which is used as the conductive connection according to the invention), stiffening it, or may be part of the plastic injection-molded element already described.

Particularly for use in motor vehicles, it is expedient for the electrically conductive connection to be at least partially surrounded in the area of the conductive contact with the spring contacts by a protective housing, which rests on the main printed circuit board, forming a seal. This protective housing can advantageously be formed integrally with the already described molding and the plastic injection-molded element. The manufacturing effort can be reduced further by the spring contacts being in the form of SMD components.

In order to ensure that the electrically conductive connection is in a secure position which is always reproducible when using a flexible printed circuit, it is expedient for the flexible printed circuit to be attached to the housing by means of adhesive bonding. Another expedient variant of the fixing of the flexible printed circuit provides for attachment to the housing and/or to the molding by means of sprung latching hooks.

The apparatus according to the invention as described above, and with its expedient developments, is supported in particular by an assembly method in which an electric motor is placed on a base mount in an installation direction in a first step, with a main printed circuit board, which has a recess for the electric motor, being arranged essentially parallel to the base mount in a final position in a second step, and with the main printed circuit board being provided with contact points which make an electrically conductive connection with connecting contacts on the electric motor on reaching the final position.

The arrangement described above, together with its expedient developments, is used particularly advantageously for smart-card insertion of a digital tachograph in a motor vehicle, since this application is subject to particular requirements for physical space, robustness and installation friendliness, in particular taking into account the extreme thermal and mechanical constraints.

### BRIEF DESCRIPTION OF THE DRAWINGS

One specific exemplary embodiment of the invention will be described in more detail in the following text, in order to explain the invention, with reference to drawings, in which:

FIG. 1 shows a plan view of a flexible printed circuit,

FIG. 2 shows a perspective illustration of a main printed circuit board,

FIG. 3 shows a perspective, partial illustration of an arrangement according to the invention, having an electric motor and a flexible printed circuit,

FIG. 4 shows a perspective illustration of an arrangement according to the invention, having an electric motor, a flexible printed circuit, a molding and a base mount,

FIG. 5 shows a perspective illustration of an arrangement according to the invention, having an electric motor, a flexible printed circuit, a base mount and a main printed circuit board,

FIG. 6 shows a section through a plastic injection-molded element having an electrically conductive connection according to the invention,

FIG. 7 shows a perspective illustration of an arrangement according to the invention, having an electric motor, a plastic injection-molded element, a base mount and a main printed circuit board, which is indicated.

### DETAILED DESCRIPTION

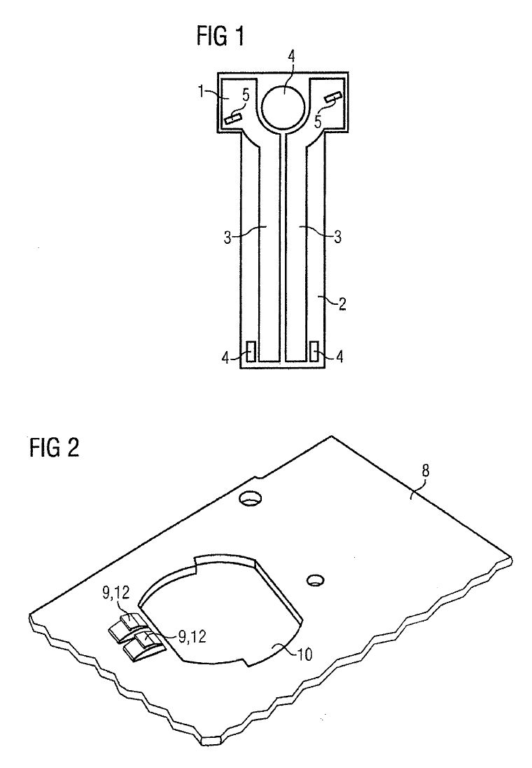

In the illustration in FIG. 1, a flexible printed circuit is provided with the reference symbol 1, and essentially comprises a non-conductive mount material 2 and two conductive conductor tracks 3 which are separated from one another. The mount material 2 is provided with three recesses 4 which are used for attachment of the flexible printed circuit 1, and the two conductor tracks 3 each have an aperture opening 5 for one respective connecting contact 6 of an electric motor 7, which is illustrated by way of example in FIG. 3.

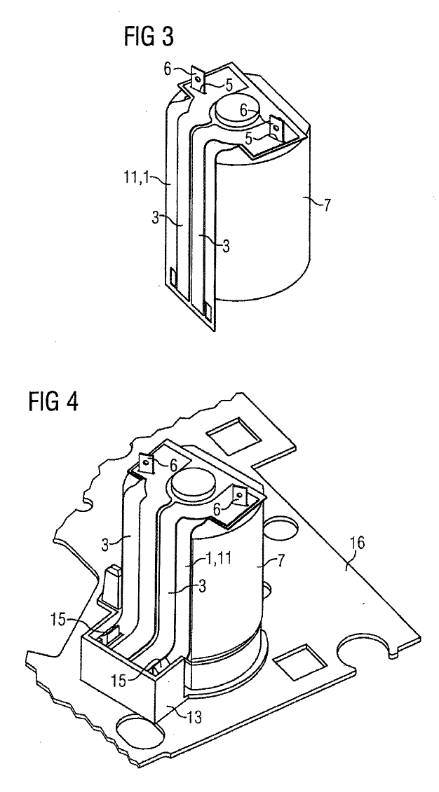

In addition to other components which are not illustrated, a main printed circuit board 8 as illustrated in FIG. 2 is fitted with two spring contacts 9, with which an electrically conductive connection 10, for example the flexible printed circuit 1 in FIG. 1, makes contact during assembly. Adjacent to the spring contacts 9, the main printed circuit board 8 is provided with a recess 10 into which, for example, the electric motor 7 that is illustrated in FIG. 3 can be inserted.

FIG. 3 shows the combination of the electric motor 7 and an electrically conductive connection 11, in the form of the flexible printed circuit 1 illustrated in FIG. 1. The connecting contacts 6 of the electric motor 7 are in the form of sheet-metal strips, and are passed through the aperture openings 5 in the conductor tracks 3.

FIG. 4 shows the combination according to the invention, which carries on further, of the elements shown in FIG. 3, with a base mount 16 using a molding 13, by means of which the electrically conductive connection 11 is pressed against the contact points 12, which cannot be seen in the illustration but are in the form of spring contacts 9. The electrically conductive connection 11 is attached to the molding 13 by means of latching hooks 15, so as to ensure that the conductor tracks 3 are always in the correct position.

FIG. 5 shows the combination of the elements illustrated in FIG. 4 with the main printed circuit board 8, in which case spring contacts 9 which actually cannot be seen from this perspective and are thus illustrated in the form of dashed lines, on the lower face of the main printed circuit board 8 are connected to the conductor tracks 3 on the flexible printed circuit 1.

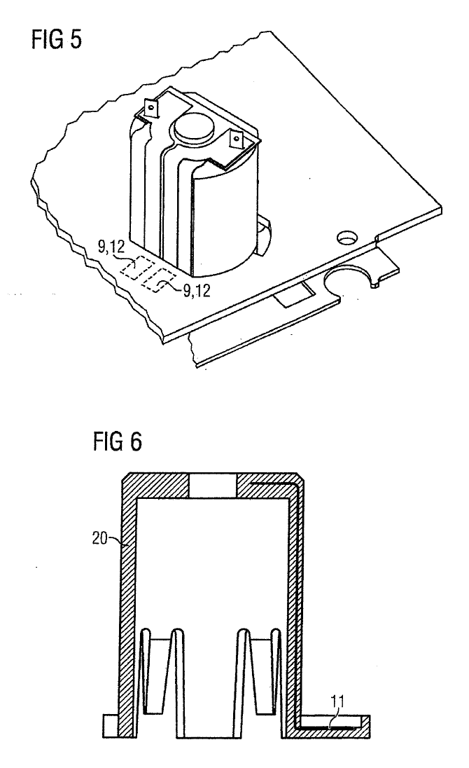

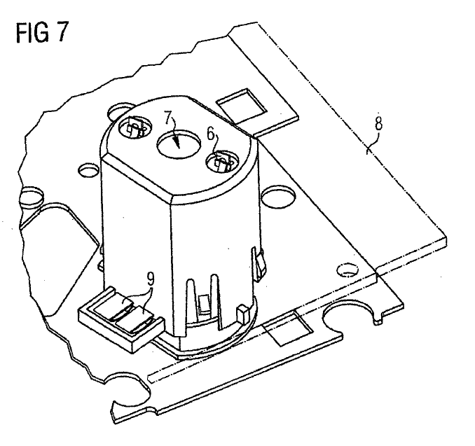

FIG. 6 shows a plastic injection-molded element with an electrically conductive connection 11 embedded using the insert process. The electrically conductive connection 11 is in this case in the form of a sprayed-in contact plate 21 and has surfaces without insulation in those areas in which, as shown in the illustration in FIG. 7, it makes an electrically conductive connection with the connecting contacts 6 of the electric motor 7, and the spring contacts 9. The plastic injection-molded element 20 forms, comparatively speaking, an outer housing for the electric motor 7, which, on one side of the printed circuit, is virtually completely surrounded thereby. This results not only in electrical conduction between the electrically conductive connection 11 and the connecting contacts 6 of the electric motor 7 and electrical conduction between the electrically conductive connection 11 and the spring contacts 9, but also in the electric motor 7 being attached to the main printed circuit board 8. The attachment to the main printed circuit board 8 is provided by latching hooks 23.

What is claimed is:

1. An arrangement comprising an electric motor and a main printed circuit board with contact points, wherein
the electric motor has a housing and connecting contacts which are electrically conductively connected to the contact points,
the housing has a first end face and a second end face opposite it,
the connecting contacts are arranged in the area of the second end face on the housing, with the electric motor being arranged with respect to the main printed circuit board in such a manner that the second end face faces away from the main printed circuit board,
the electrically conductive connection is resistant to bending, at least for torques which are oriented in a direction at right angles to the longitudinal extent of the electrically conductive connection,
the main printed circuit board has a recess in which the electric motor is arranged,
the contact points on the main printed circuit board are in the form of spring contacts, and are arranged on the lower face of the main printed circuit board,
and wherein
the electrically conductive connection is attached to a molding, by means of which the electrically conductive connection is electrically conductively pressed against the spring contacts.

2. The arrangement according to claim 1, wherein the electrical connection comprises at least one flexible printed circuit.

3. The arrangement according to claim 1, wherein the electrically conductive connection is surrounded by a plastic injection-molded element, in order to stiffen it.

4. The arrangement according to claim 3, wherein the electrical connection runs in a meandering shape in the plastic injection-molded element.

5. The arrangement according to claim 3, wherein the plastic injection-molded element at least partially surrounds the electric motor in such a manner that the electric motor is held in a cavity between the main printed circuit board and the plastic injection-molded element.

6. The arrangement according to claim 3, wherein the plastic injection-molded element has sprung latching hooks, by means of which it is attached to the main printed circuit board.

7. The arrangement according to claim 1, wherein a drive shaft of the electric motor is oriented at right angles to the main printed circuit board, and projects out of the first end face.

8. The arrangement according to claim 1, wherein the electrically conductive connection is at least partially surrounded in the area of the conductive contact with the spring contacts by a protective housing, which rests on the main printed circuit board, forming a seal.

9. The arrangement according to claim 8, wherein the spring contacts are in the form of SMD components.

10. The arrangement according to claim 2, wherein the flexible printed circuit is attached to the housing by means of adhesive bonding.

11. The arrangement according to claim 2, wherein the flexible printed circuit is attached to the housing and/or to the molding by means of sprung latching hooks.

12. A method for assembly of an arrangement comprising the steps of:
placing an electric motor on a base mount in an installation direction in a first step,
arranging a main printed circuit board, which has a recess for the electric motor, essentially parallel to the base mount in a final position in a second step, so that the electric motor is arranged in the main printed circuit board,
providing the main printed circuit board on its lower face with contact points which are in the form of spring contacts and are electrically connected to connecting contacts on the electric motor on reaching the final position, in that an electrically conductive connection, which is connected to the connecting contacts, is electrically conductively pressed against the contact points by means of a molding.

13. The method according to claim 12, wherein the electrical connection comprises at least one flexible printed circuit.

14. The method according to claim 1, wherein the electrically conductive connection is surrounded by a plastic injection-molded element, in order to stiffen it.

15. The method according to claim 14, wherein the electrical connection runs in a meandering shape in the plastic injection-molded element.

16. The method according to claim 14, wherein the plastic injection-molded element at least partially surrounds the electric motor in such a manner that the electric motor is held in a cavity between the main printed circuit board and the plastic injection-molded element.

17. The method according to claim 14, wherein the plastic injection-molded element has sprung latching hooks, by means of which it is attached to the main printed circuit board.

18. The method according to claim 12, wherein a drive shaft of the electric motor is oriented at right angles to the main printed circuit board, and projects out of the first end face.

19. The method according to claim 12, wherein the electrically conductive connection is at least partially surrounded in the area of the conductive contact with the spring contacts by a protective housing, which rests on the main printed circuit board, forming a seal.

20. The method according to claim 19, wherein the spring contacts are in the form of SMD components.

21. The method according to claim 13, wherein the flexible printed circuit is attached to the housing by means of adhesive bonding.

22. The method according to claim 13, wherein the flexible printed circuit is attached to the housing and/or to the molding by means of sprung latching hooks.
